(19) United States
(12) Patent Application Publication
(10) Pub. No.: US 2015/0180865 A1
(43) Pub. Date: Jun. 25, 2015

(54) Device and method for identity authentication

(71) Applicants: Kwok fong Wong, Heshan (CN); Pui yi Ching, Heshan (CN)

(72) Inventors: Kwok fong Wong, Heshan (CN); Pui yi Ching, Heshan (CN)

(73) Assignee: WWTT TECHNOLOGY CHINA, Jiangmen (CH)

(21) Appl. No.: 13/881,364

(22) PCT Filed: Nov. 10, 2012
(86) PCT No.: PCT/CN2012/084421

§ 371 Date: Apr. 24, 2013

(30) Foreign Application Priority Data
Aug. 13, 2012 (CN) 201210285035.5

(51) Int. Cl. H04L 29/06

(52) U.S. Cl. CPC H04L 63/0861; H04L 63/0838

(57) ABSTRACT

A device for identity authentication is disclosed in the invention, which comprises a client and a background, wherein the client comprises a plurality of terminal units and fingerprint sensors interconnecting with each terminal unit, each fingerprint sensor includes a collection and recognition device for collecting fingerprint information and a memory for storing fingerprint information and user information of the user corresponding to the fingerprint information. the background includes a identity authentication server interconnecting with the terminal units, and multiple application servers interconnecting with the identity authentication server. The terminal units are used for registering or confirming fingerprint information collected by the fingerprint sensors to distinguish the identities of users, and transmitting the result of registering or confirming to the identity authentication server of the background and the identity authentication server decides the permissions of users on the multiple application servers according to the result.

### FIELD OF THE INVENTION

The invention relates to a device and a method for identity authentication.

### DESCRIPTION OF THE RELATED ART

Currently, various user information can be stored in some social network platforms, such as user name, password, figures, address, ID card No., and email and the like, however, these information usually can not represent the true identity of a user.

Each network user can create a plurality of network accounts, thus, many users usually create multiple different accounts for many times due to forgetting user names or passwords, this causes waste of resources.

Furthermore, this may cause damage to the public safety. For example, some network users can create many false accounts by means of different identity information to provide illegal service.

### SUMMARY OF THE INVENTION

An object of the invention is to provide a device and method for identity authentication, to file fingerprint biology information. Everyone has unique fingerprint information, thus one people just can create only one account with true identity information according the invention, and this avoids the problems of safety and waste of resources.

The following technical solution is employed in this invention: a device for identity authentication, comprising:
a client, which comprises a plurality of terminal units and multiple fingerprint sensors interconnecting with each of the terminal units respectively,
wherein each of the fingerprint sensors includes a collection and identification device for collecting fingerprint information and a memory for storing fingerprint information and user information of users corresponding to the fingerprint information; and
a background, which comprises an identity authentication server interconnecting with the terminal units and a plurality of application servers interconnecting with the identity authentication server;
   wherein the terminal units are used for registering or recognizing the fingerprint information collected by the fingerprint sensors to distinguish user's identity, and transmitting the result of registering or recognizing to the identity authentication server of the background, and permissions of users on the plurality of application servers will be decided according to the result by the identity authentication server.

Preferably, the identity authentication server includes a user authentication unit for identifying the user identity and a user archive management unit for storing the registered user information.

More preferably, each terminal unit is provided with a OTP password, and the user archive management unit being provided with a OTP key, the OTP password being sent to the identity authentication server by the terminal units after confirming the matching of the fingerprint information, and the OTP password being matched to the OTP key in the user archive management unit by the user authentication unit.

More preferably, each fingerprint sensor is provided with a unique sensor ID, the user archive management unit being provided with a sensor ID archive, the sensor ID of the fingerprint sensor being transmitted to the identity authentication server by the terminal units after confirming the matching of the fingerprint information, and the sensor ID being matched to the sensor ID archive of the user archive management unit by the user authentication unit of the identity authentication server.

Still more other preferably, the terminal units interconnect with the identity authentication server and the identity authentication server interconnects with the application servers through a network respectively.

The present invention also discloses a method for identity authentication, comprising a step (A) of registering and a step (B) of authenticating,

wherein the step (A) also includes the steps of:
(A1) extracting fingerprint information of a user by the collection and recognition device of fingerprint sensor and generating a public key and a private key corresponding to each other;
(A2) storing the private key in the memory of the fingerprint sensor;
(A3) transmitting the public key to the identity authentication server by a host computer, and generating a new registered user at the time of storing the public key in the identity authentication server; and
   the step (B) also including the steps of:
(B1) extracting fingerprint information of a user by the collection and recognition device of fingerprint sensor, and comparing the fingerprint information through the memory by the terminal unit, and performing the next step if matching, or otherwise canceling the next step;
(B2) taking out the private key from the memory and transmitting it to the identity authentication server by the terminal unit;
(B3) matching the private key to the public key to authenticate a user by the identity authentication server.

Preferably, the method further comprises a step (B4) between the step (B1) and step (B2), each terminal unit being provided with a OTP password, the identity authentication server being provided with a OTP key, and the OTP password being transmitted to the identity authentication server after confirming the matching of the fingerprint information, and the OTP password being matched to the OTP key by the identity authentication server.

More preferably, the method further comprises a step (B5) between the step (B1) and step (B2), each fingerprint sensor being provided with a unique sensor ID, and the identity authentication server being provided with a sensor ID archive, the sensor ID of the fingerprint sensor being transmitted to the identity authentication server after confirming the matching of the fingerprint information, and the sensor ID of the fingerprint sensor being matched to the sensor ID archive by the identity authentication server.

More preferably, the method further comprises a step (B6) after step (B3), encrypting or decrypting data on the multiple application servers after authenticating a user successfully.

Still more preferably, the terminal units interconnect with the identity authentication server, and the identity authentication server interconnects with the application servers through a network respectively.

By means of the above configuration or method, the present invention has the following advantages:
1. By utilizing the device of identity authentication of the invention, the identity of any user is unique and true, and if necessary, the user identity can be traceable, and furthermore the user archive in server is not reproducible.
2. According to the invention, fingerprint information is stored in fingerprint device locally and just belongs to the special user, thus, high-privacy is provided by utilizing such a device or method.
3. According to the invention, authenticating a user identity is performed by means of multiple-factors instead of password or fingerprint solely, for example, a user can pass the identity authentication only when his/her fingerprint, sensor ID, and one-time password (OTP) are matched successfully.
4. According to the device or method in this invention, all the data on the platform of the invention is protected via a key to ensure the safety of data, thus, the security is improved greatly based on avoiding the wastes of resources in such a platform.

### BRIEF DESCRIPTION OF THE DRAWINGS

FIG. 1 is a schematic diagram of a device for identity authentication according to the invention.

### DETAILED DESCRIPTION OF THE INVENTION

Preferred embodiments of the present invention will now be described in more detail hereinafter with reference to the drawings, so that the advantages and features of the invention can be easily understood by a person skilled in the art, thereby the protection scope of the invention can be defined more clearly.

A method for identity authentication comprises:

a step (A) of registering including:
extracting fingerprint information of a user by the collection and recognition device of fingerprint sensor and generating a public key and a private key corresponding to each other;
storing the private key in the memory of the fingerprint sensor;
transmitting the public key to the identity authentication server by a host computer, and generating a new registered user at the time of storing the public key in the identity authentication server;
sending a message encrypted via a private key;
identifying the message from the sender using a public key; and
   a step (B) of authenticating including:
extracting fingerprint information of a user by the collection and recognition device of fingerprint sensor, and comparing the fingerprint information through the memory by the terminal unit, and performing the next step if matching, or otherwise canceling the next step;
taking out the private key from the memory and transmitting it to the identity authentication server by the terminal unit;
matching the private key to the public key to authenticate a user by the identity authentication server.

When the identity authentication of a user is passed successfully, encrypting or decrypting data can be performed on one or more application servers by the user.

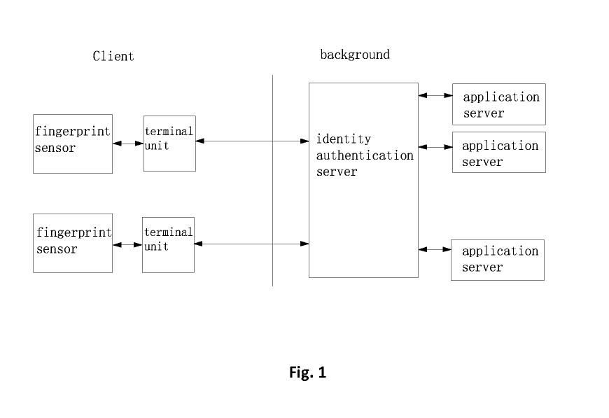

As shown in FIG. 1, a device for identity authentication comprising a client and a background.

The client comprises a plurality of terminal units and multiple fingerprint sensors interconnecting with each of the terminal units, and each of the fingerprint sensors includes a collection and identification device for collecting fingerprint information and a memory for storing fingerprint information and user information of users corresponding to the fingerprint information.

The background comprises an identity authentication server interconnecting with the terminal units and a plurality of application servers interconnecting with the identity authentication server.

The terminal units are used for registering or recognizing the fingerprint information collected by the fingerprint sensors to distinguish a uses identity, and transmitting the result of registering or recognizing to the identity authentication server of the background, and permissions of users on the plurality of application servers can be decided according to the result by the identity authentication server.

The identity authentication server includes a user authentication unit for identifying the user identity and a user archive management unit for storing the registered user information.

Each terminal unit is provided with a OTP password, and the user archive management unit is provided with a OTP key, the OTP password is sent to the identity authentication server by the terminal units after confirming the matching of the fingerprint information, and the OTP password is matched to the OTP key in the user archive management unit by the user authentication unit.

Each fingerprint sensor is provided with a unique sensor ID, the user archive management unit is provided with a sensor ID archive, the sensor ID of the fingerprint sensor is transmitted to the identity authentication server by the terminal units after confirming the matching of the fingerprint information, and the sensor ID is matched to the sensor ID archive of the user archive management unit by the user authentication unit of the identity authentication server.

The terminal units interconnect with the identity authentication server, and the identity authentication server interconnects with the application servers through a network respectively.

Each of the fingerprint sensors includes a memory and a collection and recognition device. A fingerprint sensor extracts biology fingerprint information of a user when he/she registers or authenticates, the fingerprint information is stored in the memory together with private key and other information of the user. The private key and the corresponding public key are algorithms of encrypting and decrypting generated according to the registered fingerprint information of the user. The private key is stored in the memory of the fingerprint sensor, and the public key is transmitted to the identity authentication server. Once the user identity passes authentication, the keys match to each other successfully, and the user can encrypt or decrypt data on different applications.

The terminal units are used for registering or recognizing fingerprint information, which can be computer, panel computer or telephone and the like. Also, one-time password (OTP) is stored in a terminal unit, which is used for identity authentication after confirming the fingerprint information. The one-time password (OTP) can generates different passwords in different cases. Thus, sensor ID, one-time password and messages encrypted via private key are sent to the identity authentication server for confirmation. If the user is authenticated, the different applications in the server can be used and the data is protected by encrypting.

The identity authentication server comprises a user authentication unit and a user archive management unit.

The user authentication is completed in the user authentication unit by matching the one-time password, sensor ID of the host computer and decrypting the encrypted messages, if the above information is matched successfully, then it can be determined that the user identity is true, and the user is permitted to use applications on the platform.

The user archive management unit manages the archives of the registered users, and all the archives are be stored and managed by system, including OTP key, sensor ID, fingerprint data information (such as fingerprint numbers of registered users), public key, user group or user privilege and the like. These archives are used for authenticating or communicating with different application servers.

In order to achieve different functions, a device for identity authentication can comprises many different application servers, which can be mail, chat, file sharing and the like. The identity authentication server authenticates the true identity of a user, and each of the users on the identity authentication device is the one registered actually, and thus any user can chat with the others safely. The one who sent mails is approved, and only the registered users can read their mails. Furthermore, the registered users on the device for identity authentication can constitute different groups with different users according to group information in the archives of the identity authentication server. People can share private documents, music or video files in same group, and only the registered users authenticated successfully can access these files. Thus, the identities of all of the registered users are approval.

Preferred embodiments are illustrated with reference to the accompanying drawings herein, however, it is obvious for a person skilled in the art that various modifications or variations can be made to the invention without departing from the spirit and protecting scope of the present invention, and such variations or variations would be covered within the protection scope of the invention.

What is claimed is:

1. A device for identity authentication, comprising:
a client, which comprises a plurality of terminal units and multiple fingerprint sensors interconnecting with each of the terminal units respectively,
wherein each of the fingerprint sensors includes a collection and identification device for collecting fingerprint information and a memory for storing fingerprint information and user information of users corresponding to the fingerprint information; and
a background, which comprises an identity authentication server interconnecting with the terminal units and a plurality of application servers interconnecting with the identity authentication server;
wherein the terminal units are used for registering or recognizing fingerprint information collected by the fingerprint sensors to distinguish user identities, and transmitting the result of registering or recognizing to the identity authentication server of the background, and permissions of users on the plurality of application servers will be decided according to the result by the identity authentication server.

2. The device for identity authentication as claimed in claim 1, wherein the identity authentication server includes a user authentication unit for identifying the user identity and a user archive management unit for storing the registered user information.

3. The device for identity authentication as claimed in claim 2, wherein each terminal unit is provided with a OTP password, and the user archive management unit being provided with a OTP key, the OTP password being sent to the identity authentication server by the terminal units after confirming the matching of the fingerprint information, and the OTP password being matched to the OTP key in the user archive management unit by the user authentication unit.

4. The device for identity authentication as claimed in claim 2, wherein each fingerprint sensor is provided with a unique sensor ID, the user archive management unit being provided with a sensor ID archive, the sensor ID of the fingerprint sensor being transmitted to the identity authentication server by the terminal units after confirming the matching of the fingerprint information, and the sensor ID being matched to the sensor ID archive of the user archive management unit by the user authentication unit of the identity authentication server.

5. The device for identity authentication as claimed in claim 1, wherein the terminal units interconnect with the identity authentication server and the identity authentication server interconnects with the application servers through a network respectively.

6. A method for identity authentication, comprising a step (A) of registering and a step (B) of authenticating,
wherein the step (A) also includes the steps of:
(A1) extracting fingerprint information of a user by the collection and recognition device of fingerprint sensor and generating a public key and a private key corresponding to each other;
(A2) storing the private key in the memory of the fingerprint sensor;
(A3) transmitting the public key to the identity authentication server by a host computer, and generating a new registered user at the time of storing the public key in the identity authentication server; and
the step (B) also including the steps of:
(B1) extracting fingerprint information of a user by the collection and recognition device of fingerprint sensor, and comparing the fingerprint information through the memory by the terminal unit, and performing the next step if matching, or otherwise canceling the next step;
(B2) taking out the private key from the memory and transmitting it to the identity authentication server by the terminal unit;
(B3) matching the private key to the public key to authenticate a user by the identity authentication server.

7. The method for identity authentication as claimed in claim 6, wherein the method further comprises a step (B4) between the step (B1) and step (B2), each terminal unit being provided with a OTP password, the identity authentication server being provided with a OTP key, and the OTP password being transmitted to the identity authentication server after confirming the matching of the fingerprint information, and the OTP password being matched to the OTP key by the identity authentication server.

8. The method for identity authentication as claimed in claim 6, wherein the method further comprises a step (B5) between the step (B1) and step (B2), each fingerprint sensor being provided with a unique sensor ID, and the identity authentication server being provided with a sensor ID archive, the sensor ID of the fingerprint sensor being transmitted to the identity authentication server after confirming the matching of the fingerprint information, and the sensor ID of the fingerprint sensor being matched to the sensor ID archive by the identity authentication server.

9. The method for identity authentication as claimed in claim 6, wherein the method further comprises a step (B6) after step (B3), encrypting or decrypting data on the multiple application servers after authenticating a user successfully.

10. The method for identity authentication as claimed in claim 6, wherein the terminal units interconnect with the identity authentication server, and the identity authentication server interconnects with the application servers through a network respectively.
